(19) United States
(12) Patent Application Publication
(10) Pub. No.: US 2013/0085969 A1
(43) Pub. Date: Apr. 4, 2013

(54) DUAL TIER MARKETING SYSTEM FOR CONSUMER PRODUCTS

(71) Applicants: Amy Schroeder Kelly, Cincinnati, OH (US); Gina Barattieri Tesnar, Newport, KY (US)

(72) Inventors: Amy Schroeder Kelly, Cincinnati, OH (US); Gina Barattieri Tesnar, Newport, KY (US)

(21) Appl. No.: 13/251,516

(22) Filed: Oct. 3, 2011

(51) Int. Cl. G06Q 90/00

(52) U.S. Cl. 705/500

(57) ABSTRACT

A two tier system of marketing cleaning products. The tiers are differentiated by artwork showing a first tier to have cleaning products usable for certain cleaning tasks and a second tier to have corresponding cleaning products. The cleaning products of the second tier may be marketed to the consumer as being better than the cleaning products of the first tier.

### FIELD OF THE INVENTION

The present invention relates to cleaning products and more particularly to marketing thereof in a tiered system providing the consumer a choice of corresponding products from each tier.

### BACKGROUND OF THE INVENTION

Cleaning products are well known in the art. Branded cleaning products include Swiffer® cleaning products, sold by the instant assignee. Swiffer® cleaning products include Swiffer® Dusters®, usable for cleaning for a variety of surfaces. Swiffer® cleaning products particularly include Swiffer® Sweeper® dry cleaning cloths, Swiffer® WetJet® pads and Swiffer® Wet cleaning cloths, usable for cleaning a floor and similar target surfaces.

These cleaning products typically comprise an implement and a refill. The implement may hold and/or allow the user to ergonomically manipulate the refill during the cleaning process. The implement is typically reused for many cleaning cycles. The refill is typically used for one cleaning cycle, then discarded. A new refill may be used for the next cleaning cycle.

Such cleaning products are relatively inexpensive. They typically do not represent a major expenditure for the consumer, even when an implement is purchased. However, once a consumer purchases an implement, he/she typically uses that implement throughout its useful life. The useful life may last for more than a year and through multiple cleaning cycles. If the consumer does not purchase the appropriate implement, each cleaning cycle may be sub-optimal.

For example, some implements may be suited for everyday or weekly cleaning tasks. Other, and corresponding, cleaning implements may be suitable for more thorough, deeper cleaning tasks.

For example, a Swiffer® Sweeper® implement comprising a handle connected to a head through a universal joint may be suitable for everyday cleaning. A refill cloth is removably attached to the bottom of the head and typically used for a single cleaning task. When the task is completed, the user simply disposes of the cleaning cloth from the bottom of the head.

But if deeper cleaning is desired, the user may select a corresponding Swiffer® SweeperVac® implement. This implement augments the disposable cleaning cloth with suction for cleaning particles not captured by the disposable cloth. Better cleaning occurs. But when the task is completed, the user must not only dispose of the cloth, but must also occasionally empty the dirt bin and clean the filter. More steps are associated with the deeper cleaning task.

This difference between the everyday level of cleaning and the deeper level of cleaning is not easy to communicate to the consumer. The consumer may make a hasty decision online or in the quick-clean aisle when purchasing one or more cleaning implements. But if the wrong implement is selected, the consumer may become dissatisfied and be lost as a customer.

To overcome this problem in the purchase of durable goods, manufacturers have used tiered marketing. For example, General Motors used to market corresponding automobiles having a common platform under the Chevrolet, Buick, Pontiac, Oldsmobile and/or Cadillac brand names. The differences were often a matter of trim, horsepower and prestige. But an automobile marketed towards one driver may be poorly suited for another. For example, a driver seeking a sporty Chevrolet Camaro may be dissatisfied with a corresponding luxury car marketed under the Cadillac brand.

Cascade® automatic dishwashing detergent, marketed by the instant assignee, has various product forms with varying degrees of performance. One consumer may want a gel form, while another consumer may want a powder form. Yet both may want to avoid bleach in their product. The consumer may not know which product to select from those which do not contain bleach.

In another example, Sears markets hand tools under the Master Forge brand name and under the

Craftsman brand name. The Craftsman tools can be returned if the they should ever fail to provide complete satisfaction, i.e. should break due to any cause. The Master Forge tools do not have this warranty.

But these examples are not directly applicable to the consumer in the quick clean aisle. The consumer in this aisle typically does not spend considerable time on such purchase. The consumer may be confronted with dual tier products marketed under the same brand name, and not even recognize the dual tiers. Even if the consumer recognizes the tiers, the consumer may not understand which cleaning product belongs in a particular tier or is more suitable for a particular task.

Thus, the need for improved marketing of cleaning products continues. Furthermore, the need for improved marketing of cleaning products online and in a brick/mortar store continues.

### SUMMARY OF THE INVENTION

The invention comprises a display arrangement usable in a store or on the internet. The display arrangement comprises a first tier of cleaning products having a first cleaning efficacy; and a second tier of cleaning products having a second cleaning efficacy. The second cleaning efficacy is greater than the first cleaning efficacy.

### BRIEF DESCRIPTION OF THE DRAWINGS

FIG. 1 is a frontal view of packaging suitable for containing, advertising and/or sale of a dry refill cleaning sheet usable as a first tier and/or second tier cleaning sheet.

FIG. 2 is a frontal or top view of packaging suitable for containing, advertising and/or sale of a first tier wet refill cleaning sheet.

FIG. 3 is a frontal of packaging suitable for containing, advertising and/or sale of a first tier implement usable with a dry refill cleaning sheet and/or wet refill cleaning sheet.

FIG. 4 is a frontal of packaging suitable for containing, advertising and/or sale of a second tier implement usable with a dry refill cleaning sheet.

FIG. 5 is a frontal of packaging suitable for containing, advertising and/or sale of a second tier wet refill cleaning sheet and cleanser therefor.

FIG. 6 is a frontal of packaging suitable for containing, advertising and/or sale of a second tier wet cleaning implement.

FIG. 7 is a frontal of packaging suitable for containing, advertising and/or sale of a first tier dusting refill and first tier dusting implement.

FIG. 8 is a frontal of packaging suitable for containing, advertising and/or sale of a second tier dusting refill and first tier dusting implement.

FIG. 9 is a frontal of packaging suitable for containing, advertising and/or sale of a second tier dusting implement.

### DETAILED DESCRIPTION OF THE INVENTION

The invention comprises a display system for corresponding cleaning products distinguished by placement into two or more tiers. Cleaning products are considered to be corresponding if they are typically used for substantially the same cleaning task. For example, corresponding products may be used for dry floor cleaning, for wet floor cleaning, for dusting, etc.

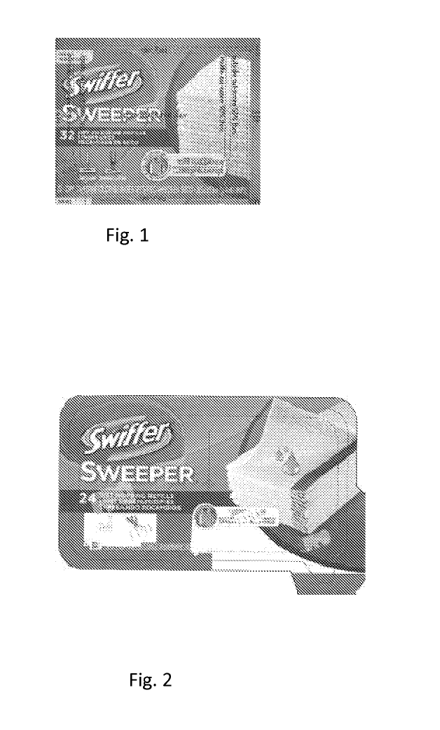

Referring to FIG. 1, one form of a cleaning sheet usable as a refill according to the present invention may comprise a nonwoven. The nonwoven may be synthetic and/or have cellulosic fibers therein. The synthetic fibers may comprise carded, staple, wet laid, air laid and/or spunbond fibers. The nonwoven cleaning sheet may be made according to a hydro-entangling process to provide a texture and a basis weight of about 20 to about 120 gsm.

Optionally, the refill cleaning sheet may further comprise an additive, to improve cleaning performance and/or enhance the cleaning experience. The additive may comprise wax, such as microcrystalline wax, oil, adhesive, perfume and combinations thereof. The cleaning sheet according to the present invention may be made according to commonly assigned U.S. Pat. Nos. 6,305,046; 6,484,346; 6,561,354; 6,645,604; 6,651,290; 6,777,064; 6,790,794; 6,797,357; 6,936,330; D409,343; D423,742; D489,537; D498,930; D499,887; D501,609; D511,251 and/or D615,378. Such a cleaning sheet may be usable with corresponding implements as either a first tier or a second tier cleaning sheet.

Referring to FIG. 2, if desired, a first tier refill cleaning sheet may be pre-moistened. Of course, depending upon positioning in the marketplace, a pre-moistened cleaning sheet may be a second tier cleaning sheet. If the refill cleaning sheet is pre-moistened, it may be pre-moistened with a liquid which provides for cleaning of the target surface, such as a floor, but yet does not require a post-cleaning rinsing operation.

The pre-moistened cleaning sheet may comprise natural or synthetic fibers. The fibers may be hydrophillic, hydrophobic or a combination thereof, provided that the cleaning sheet is generally absorbent to hold, and express upon demand, a cleaning solution. In one embodiment, the cleaning sheet may comprise at least 50 weight percent or at least 70 weight percent cellulose fibers, such as air laid SSK fibers. If desired, the cleaning sheet may comprise plural layers to provide for scrubbing, liquid storage, and other particularized tasks for the cleaning operation.

The cleaning sheet may be loaded with at least 1, 1.5 or 2 grams of cleaning solution per gram of dry substrate, but typically not more than 5 grams per gram. The cleaning solution may comprise a surfactant, such as an APG surfactant which minimizes streaking since there is typically not a rinsing operation, agglomerating chemicals, disinfectants, bleaching solutions, perfumes, secondary surfactants, etc.

Optionally, the pre-moistened cleaning sheet may further comprise a scrubbing strip. A scrubbing strip is a portion of the cleaning sheet which provides for more aggressive cleaning of the target surface. A suitable scrubbing strip may comprise a polyolefinic film, such as LDPE, and have outwardly extending perforations, etc. A suitable pre-moistened cleaning sheet may be made according to the teachings of commonly assigned U.S. Pat. Nos. 6,716,805; D551,409 S and/or D614,408 S.

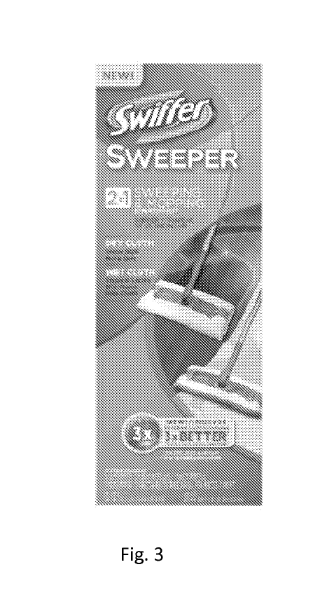

Referring to FIG. 3, the wet or dry refill cleaning sheet according to the present invention may be used with a first tier stick-type cleaning implement. Of course, depending upon positioning in the marketplace, such an implement may be a second tier implement. The cleaning implement may comprise a plastic head for holding the cleaning sheet and an elongate handle articulably connected thereto. The handle may comprise a metal or plastic tube or solid rod.

The head may have a downwardly facing surface, to which the wet or dry refill sheet may be attached. The downwardly facing service may be generally flat, or slightly convex. That may further have an upwardly facing surface. The upwardly facing surface may have a universal joint to facilitate connection of the elongate handle to the head.

The upwardly facing surface may further comprise a mechanism, such as resilient grippers, for removably attaching the cleaning sheet to the implement. Alternatively, a hook and loop system may be used to attach the cleaning sheet to the head. If grippers are used with the cleaning implement, the grippers may be made according to commonly assigned U.S. Pat. Nos. 6,305,046; 6,484,346; 6,651,290 and/or D487,173. A suitable first tier stick-type cleaning implement may be made according to commonly assigned US patents Des. 391,715; D409,343; D423,742; D481,184; D484,287; D484,287 and/or D588,770.

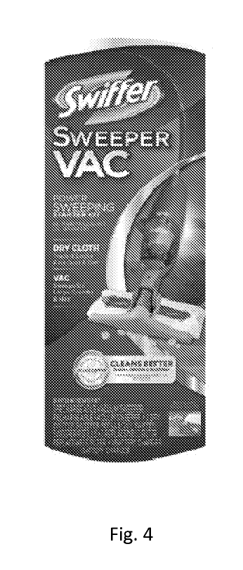

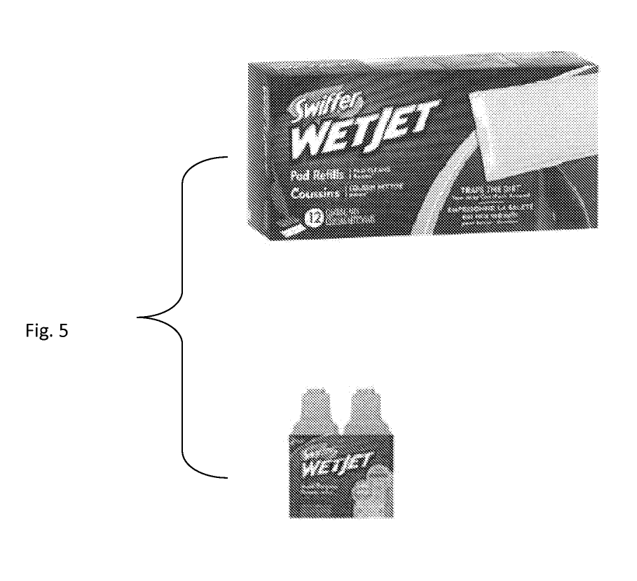

Referring to FIG. 4, if desired, a second tier dry cleaning implement may have an axially rotatable beater bar and/or vacuum type suction to assist in removal of debris from the target surface. Debris removed from the target surface may be collected in a dust bin. The dust bin may be mounted within the head, or, alternatively, on an elongate handle. A suitable second tier vacuum type cleaning implement may be made according to the teachings of U.S. Pat. Nos. 7,137,169, D484,287 S, D615,260 S and D615,378 S.

Referring to FIG. 5, a second tier wet cleaning sheet according to the present invention may comprise a nonwoven. The nonwoven may be synthetic and/or have cellulosic fibers therein. The synthetic fibers may comprise carded, staple, wet laid, air laid and/or spunbond fibers.

The cleaning sheet may comprise layers, to provide for absorption and storage of cleaning fluid deposited on the target surface. If desired, the cleaning sheet may comprise absorbent gelling materials to increase the absorbent capacity of the cleaning sheet. The absorbent gelling materials may be distributed within the cleaning sheet in such a manner to avoid rapid absorbency and absorb fluids slowly, to provide for the most effective use of the cleaning sheet.

The cleaning sheet may comprise plural layers disposed in a laminate. The lowest, or downwardly facing outer layer, may comprise apertures to allow for absorption of cleaning solution there through and to promote the scrubbing of the target surface. Intermediate layers may provide for storage of the liquids, including and included the use of absorbent gelling materials. The cleaning sheet may have been absorbent capacity of at least 10, 15, or 20 grams of cleaning solution per gram of dry cleaning sheet as set forth in commonly assigned U.S. Pat. No. 6,716,805.

The top, or upwardly facing outer layer, maybe liquid impervious in order to minimize loss of absorbed fluids. The top layer may further provide for releasable attachment of the cleaning sheet to a cleaning implement. The top layer may be made of a polyolefinic film, such as LDPE.

One of skill will recognize such refill cleaning sheets may be used with cleaning liquid. The cleaning liquid may be supplied in refillable containers and/or containers which are replaced when the cleaning liquid is depleted and not refilled. The container of cleaning liquid may be replaceably inserted into a reservoir in the cleaning implement. The cleaning solution may be made according to the teachings of commonly assigned U.S. Pat. No. 6,814,088.

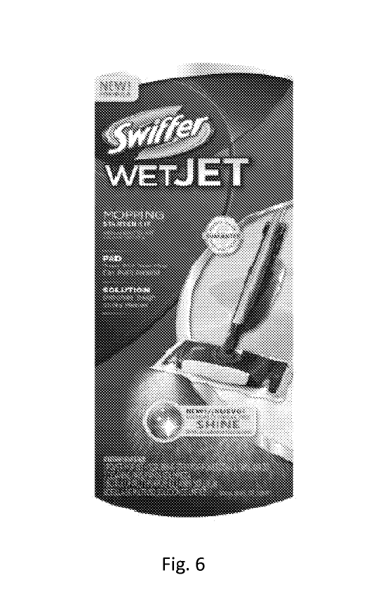

Referring to FIG. 6, a second tier wet cleaning sheet according to the present invention may be used with a comparable second tier wet cleaning implement. Such a cleaning implement may comprise a head, such as a plastic head, for holding the cleaning sheet and an elongate handle articulably connected thereto. The handle may comprise a metal or plastic tube or solid rod.

The head may have a downwardly facing surface, to which the sheet may be attached. The downwardly facing service may be generally flat, or slightly convex. That may further have an upwardly facing surface. The upwardly facing surface may have a universal joint to facilitate connection of the elongate handle to the head.

A hook and loop system may be used to attach the cleaning sheet directly to the bottom of the head. Alternatively, the upwardly facing surface may further comprise a mechanism, such as resilient grippers, for removably attaching the cleaning sheet to the implement. If grippers are used with the cleaning implement, the grippers may be made according to commonly assigned U.S. Pat. Nos. 6,305,046; 6,484,346; 6,651,290 and/or D487,173.

Such a second tier cleaning implement may further comprise a permanent or removable reservoir for storage of cleaning solution. The reservoir may be replaced when the cleaning solution is depleted and/or refilled as desired. The reservoir may be disposed on the head or the handle of the cleaning implement. The neck of the reservoir may be offset per commonly assigned U.S. Pat. No. 6,390,335.

This cleaning implement may further comprise a pump for dispensing cleaning solution from the reservoir onto the target surface, such as a floor. The pump may be battery powered or operated by line voltage. Alternatively, the cleaning solution may be dispensed by gravity flow. The cleaning solution may be sprayed through one or more nozzles to provide for distribution of the cleaning solution onto the target surface in an efficacious pattern.

If a replaceable reservoir is utilized, the replaceable reservoir may be inverted to provide for gravity flow of the cleaning solution to be pumped or directly to the dispensing nozzles. The reservoir may be a bottle, made of plastic, particularly a polyolefin. The cleaning implement may have a needle to receive the cleaning solution. The reservoir may have a needle pierceable membrane, complementary to the needle, and which is resealed to prevent undesired dripping of the cleaning solution during insertion and removal of the replaceable reservoir.

A suitable reservoir and fitment therefor may be made according to the teachings of commonly assigned U.S. Pat. Nos. 6,386,392, 7,172,099; D388,705; D484,804; D485,178. A suitable cleaning implement may be made according to the teachings of commonly assigned U.S. Pat. Nos. 5,888,006; 5,960,508; 5,988,920; 6,045,622; 6,101,661; 6,142,750; 6,579,023; 6,601,261; 6,722,806; 6,766,552; D477,701 and/or D487,174.

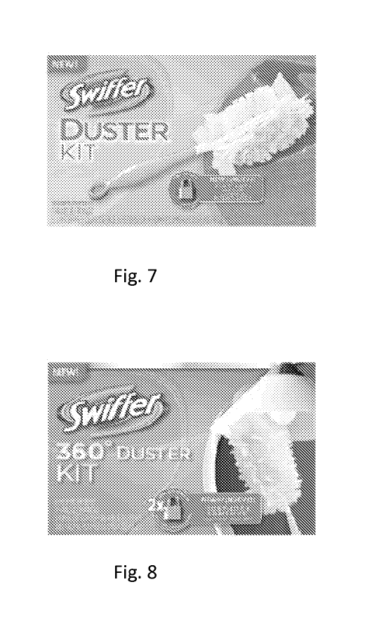

Referring to FIG. 7, a first tier refill cleaning article according to the present invention and suitable for dusting may comprise a nonwoven sheet having tow fibers joined thereto. Of course, depending upon positioning in the marketplace, such a cleaning article may be a second tier cleaning article. The cleaning article may have a longitudinal axis. The tow fibers may be joined to the nonwoven sheet in a generally transverse direction and particularly in a direction normal the longitudinal axis, to provide a laminate structure of two laminae.

If desired, the dusting cleaning article may comprise additional laminae. For example, the tow fibers may be disposed intermediate two nonwoven sheets. Plural laminae of tow fibers may be disposed intermediate the nonwoven sheets and/or outboard thereof. Optionally, one or more of the nonwoven sheets may be cut to provide comprise strips. The strips may be generally normal to the longitudinal direction of the refill article.

The tow fibers and/or nonwoven sheets may comprise an additive to assist in removal of dust and other debris from the target surface. The additive may comprise wax, such as microcrystalline wax, oil, adhesive, and combinations thereof. The cleaning article may be made according to U.S. Pat. No. 6,813,801.

The laminae of the cleaning article may be joined together using adhesive, thermal bonding, ultrasonic welding, etc. If desired, the bonding lines may be generally parallel to the longitudinal axis and may be continuous, or discontinuous as desired. Three longitudinally parallel bonding lines may be utilized to define two sleeves.

The sleeves may be used to mount the dusting refill to an implement, such as a handle. More particularly, the sleeves may accept one or more fork tines of a handle-type implement. The fork tines may be removably inserted into the sleeves of the cleaning article to provide for improved ergonomics. The handle may be plastic and made according to the teachings of U.S. Pat. Nos. 7,219,386; 7,293,317 and/or 7,383,602.

Referring to FIG. 8, if desired a second tier refill suitable for dusting may have opposing faces which present two sides to surfaces to be cleaned. This arrangement may provide for more thorough cleaning of crevices and small spaces, and may provide cleaning thought to encompass 360 degrees around the longitudinal axis of the refill. This arrangement may also provide more cleaning capacity, so that the user can continue the cleaning task using the second face when the first face of the refill is soiled to the point of being unusable.

The cleaning products according to the present invention may be displayed in one or more arrangements to make the purchase and the purchase decision more convenient. The display arrangement may be in a brick and mortar store, a catalogue, on the internet, etc. The brick and mortar store may be a hardware store, grocery store, club store, kiosk, etc. The internet may use a dedicated website, a shopping website, a social media website, etc.

Referring to FIGS. 1, 2, 3, 7 and 8 the display may comprise a first tier of cleaning products. The first tier may comprise a first plurality of various cleaning products, as described above and having a like plurality of respective first cleaning efficacies. The display may also comprise a second tier of cleaning products. Referring to FIGS. 1, 4, 5, 6, 8, and 9, the second tier may comprise a first plurality of various cleaning products, as described above and having a like plurality of respective second cleaning efficacies. Of course, both tiers may have packaging for and/or advertisements of the cleaning product refills and cleaning product implements in the respective tier. Thus the packaging and advertisements of FIGS. 1 and 8, for example could appear in the first tier or the second tier.

While the discussion herein is directed to a dual tier display system having first and second tiers, one of skill will recognize the invention is not so limited. The display system may comprise two, three or more tiers, so long as the tiers are mutually differentiated. One of skill will recognize some cleaning products may have a two-tier system, while other cleaning products have three or more tiers.

The first plurality and said second plurality of cleaning products are related with corresponding, like products. For example, both tiers may include dry sheet cleaning products, wet sheet cleaning products, wettable sheet cleaning products, dusters, spray products, etc. The number of cleaning products in the tiers may be the same or different.

But the second cleaning efficacy may be greater than the first cleaning efficacy. By greater it is meant that products in the second tier clean more thoroughly than products the first tier and/or clean equally thoroughly in the same amount of time.

Referring to FIGS. 1-9, each product in the display arrangement may comprise packaging for that product and/or advertising of that product. The packages, the products therein, and advertisements therefor may comprise or predominantly comprise, colors of a common hue. As used herein, the hue is the property of the color, as reflected from the object, which allows that color to be classified as red, orange, yellow, green, blue, indigo, violet or a gradation thereof. The tiers having colors of a common hue may be distinguished by having mutually different shades. As used herein shade refers to how light or dark the color appears to the viewer.

According to the present invention, products, packaging and/or advertisements in the first tier may have a first color and products, packaging and/or advertisements in the first tier may have a second color. The second color may be of the same hue as the first color, but of a darker shade, or vice versa.

The hue, and a particular shade thereof, may be associated with the trade dress and/or trademark of that product. The products, packaging and/or advertisements may exhibit a common brand and/or trademark. By having products, packaging and/or advertisements in both tiers exhibit the same brand and/or trademark, the consumer may more easily associate the products and tiers. Such association may help the consumer in making the proper purchase decision.

Furthermore, the cleaning the packaging and/or advertisements may show a photograph, figure or other indicium of the respective cleaning refill or implement. The photograph or figure may particularly help the consumer understand specific differences between implements and refills in the various tiers.

The display arrangement may comprise other visual differentiators. For example, products, packaging and/or advertisements in one tier may comprise a particular color not present in the other tier. More particularly, one tier may comprise a metallic color, such as silver, gold, etc. The metallic color may be used to suggest prestige, etc. and therefore used in the second tier.

Such a visual differentiator may comprise a band, wherein the band forms a border around all of or a portion of a photograph or figure of the respective cleaning device, if present. Additionally or alternatively, the band may be at an edge of the package or disposed elsewhere as desired.

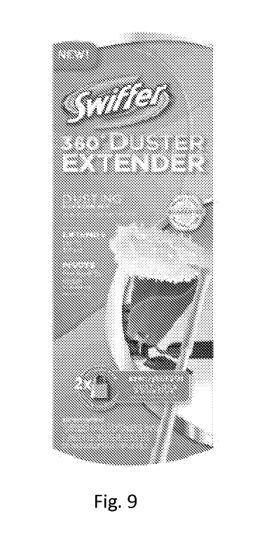

As shown in FIGS. 6 and 9, an item in the second tier may have a more elegantly shape package than a corresponding item in the first tier. An item in the first tier may simply have a parallelepipedally shaped box, as shown in FIG. 7. A package in the second tier may have rounded edges and metallic banding, as shown.

Cleaning products in the tiers may be differentiated according to functionality. For example, implements in the second tier may have additional features or functionality not found in implements in the first tier.

More particularly and referring to FIG. 9, an implement in the second tier of cleaning implements may comprise a telescoping handle. The telescoping handle may provide user convenience of various lengths being available for various tasks. Referring to FIGS. 7-8, the corresponding implement in the first tier may have a fixed length handle.

Additionally or alternatively, and referring to FIG. 4, a floor cleaning implement in the second tier may have vacuum sweeper functionality. The vacuum functionality picks up more debris and more sizes of debris than a corresponding floor cleaning implement in the first tier not having the vacuum capability.

Referring to FIG. 7, and turning to the refills, a refill such as a duster or dry floor sheet, in the first tier may have a single cleaning surface. Referring again to FIG. 8, a corresponding refill in the second tier may have cleaning surfaces on both sides. Or a refill in the second implement may be larger, have greater basis weight and/or more absorbent capacity than a corresponding refill in the first category.

Alternatively or additionally, implements in the first tier may be provided in a box and require assembly by the user, hereinafter referred to as “further assembly.” Implements in the second tier may be displayed in an assembled condition and not require user assembly. Implements which are assembled as presented to the consumer may be hung on a rack for convenient viewing and selection by the user. Such implements may not require assembly after purchase and therefore do not require “further assembly.”

Alternatively or additionally cleaning products in the tiers may be differentiated by benefits not directly related to cleaning. For example, a product in the second tier may come with a coupon or refill(s) not provided with a corresponding product in the first tier. A product in the second tier may further comprise a longer warranty and/or money back guarantee not provided with a corresponding product in the first tier.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A display arrangement in a store or on the internet, said display arrangement comprising:
a first tier of cleaning products, said first tier comprising a first plurality of cleaning products having a first cleaning efficacy; and
a second tier of cleaning products, said second tier comprising a second plurality of cleaning products having a second cleaning efficacy; said second cleaning efficacy being greater than said first cleaning efficacy,
wherein said first plurality of cleaning products and said second plurality of cleaning products are related with corresponding, like cleaning products.

2. A display of cleaning products offered for sale, said display comprising:
a first plurality of cleaning implements having a first cleaning efficacy; and
a second plurality of cleaning implements having a second cleaning efficacy; wherein said first plurality of cleaning implements and said second plurality of cleaning implements are corresponding related implements, said second plurality of cleaning implements having greater cleaning efficacy than the first plurality of cleaning implements.

3. A display arrangement according to claim 1 wherein said first tier comprises packaging having a first color and said second tier comprises packaging having a second color, said second color being of the same hue as and a darker shade than said first color.

4. A display arrangement according to claim 3 wherein said first tier and said second tier display a common brand or trademark.

5. A display arrangement according to claim 4 wherein said first tier and said second tier each show a photograph or figure of the respective cleaning device.

6. A display arrangement according to claim 5 wherein said second tier further comprises a visual differentiator, said visual differentiator comprising a metallic color.

7. A display arrangement according to claim 6 wherein said visual differentiator comprises a band, said band forming a border around at least a portion of said photograph or figure of the respective cleaning device.

8. A display of cleaning products according to claim 2, wherein said first plurality of cleaning implements and said second plurality of cleaning implements comprise wet floor cleaning implements and dry floor cleaning implements.

9. A display of cleaning products according to claim 8 wherein at least one product in said second plurality of cleaning implements comprises a telescoping handle.

10. A display of cleaning products according to claim 8 wherein at least one product in said second plurality of cleaning implements further comprises a money back guarantee.

11. A display of cleaning products according to claim 10 wherein a cleaning implement in said first plurality and a corresponding cleaning implement in said second plurality each removably receive an interchangeable disposable sheet, wipe or duster.

12. A display of cleaning products according to claim 11 wherein said first plurality of cleaning implements, said second plurality of cleaning implements and said interchangeable disposable sheet, wipe or duster are marketed under a common brand name or trademark.

13. A display of cleaning products according to claim 12 wherein at least some of said cleaning implements are hung on a rack without requiring further assembly prior to use.
